(19) United States
(12) Patent Application Publication
(10) Pub. No.: US 2015/0146550 A1
(43) Pub. Date: May 28, 2015

(54) METHOD OF AND SYSTEM FOR OPTIMIZING AN EMPIRICAL PROPAGATION PREDICTION MODEL IN A MOBILE COMMUNICATIONS NETWORK

(71) Applicant: MOTOROLA SOLUTIONS, INC, SCHAUMBURG, IL (US)

(72) Inventors: RITSUKO POLLARD, WESTON, FL (US); THOMAS N. RUBINSTEIN, ENCINITAS, CA (US); SAMIR A. SAWAYA, SAN DIEGO, CA (US)

(73) Assignee: MOTOROLA SOLUTIONS, INC, SCHAUMBURG, IL (US)

(21) Appl. No.: 14/089,265

(22) Filed: Nov. 25, 2013

(51) Int. Cl. H04W 24/02; H04W 16/18

(52) U.S. Cl. CPC H04W 24/02; H04W 16/18
USPC 370/252

(57) ABSTRACT

A propagation prediction model having adjustable parameters is optimized in a mobile communications network, by subdividing a service area into a plurality of map tiles, predicting a tile reliability from the model for each map tile, averaging the predicted tile reliability from all the map tiles to obtain a predicted average service area reliability, measuring a service area reliability for all the map tiles to obtain a measured service area reliability, comparing the predicted average service area reliability with the predicted average service area reliability, and adjusting the parameters of the model when the measured service area reliability differs from the predicted average service area reliability by a predetermined amount.

### FIELD OF THE DISCLOSURE

The present disclosure relates generally to a method of, and a system for, optimizing an empirical propagation prediction model in a mobile communications network based on service area reliability and, more particularly, to sequentially tune the model to improve propagation prediction accuracy.

### BACKGROUND

Mobile communications is experiencing enormous growth, thereby requiring proper planning, expanding, operating and optimizing of mobile communications networks. For example, in a public safety network having one or more base stations in radio communication with land mobile radios (LMRs), both vehicular and handheld, operated by public safety personnel, such as first responders, too few stations may result in spotty or unreliable radio coverage, whereas too many stations are redundant and expensive. A radio signal experiences path loss during propagation between a mobile radio and a network transceiver at a station. Path loss is the attenuation or reduction in power of the propagated radio signal and is due to myriad variable factors, e.g., the spreading of the radio signal over the distance between the radio and the station, the height and location of antennas on the radio and the station, the terrain profile (hilly, mountainous, flat, etc.), the environment (urban, suburban, rural, open, forested, sea, etc.), and so forth. For example, the radio signal could be at least partially absorbed, reflected, or diffracted by trees, buildings, etc. in its path of propagation. Similarly, in a telephone network having one or more cell towers in radio communication with handheld, mobile phones having built-in radio transceivers, too few towers can be as problematic as too many towers, and the radio signal similarly experiences path loss during propagation between a mobile phone and a network transceiver at a tower.

Determining or calculating the path loss (usually expressed in dB) is known as propagation prediction, and various prediction models, tools, systems, and methods have been employed for network planning and optimization. One popular empirical model is described by Okumura et al. in “Field Strength and its Variability in VHF and UHF Land-Mobile Radio Service,” Rev. Elec. Commun. Lab., vol. 16, no. 3, 1968, pp. 825-873 (the “Okumura model”), in which field strength versus distance for various terrains, environments, and antenna heights are predicted. Measurement test data are often used to fine tune the Okumura model, as well as other models, based on a comparison of predicted versus measured signal strength. Yet, existing tuning methods that are based solely on signal strength still leaves uncertainty in the accuracy of the propagation prediction as it relates to network performance.

Accordingly, there is a need to optimize any empirical propagation prediction model to increase the accuracy of the propagation prediction in mobile communications networks.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagrammatic view of a service area subdivided into map tiles during optimization of a propagation prediction model in accordance with the present disclosure.

FIG. 2 is a flow chart depicting initial steps performed during the optimization.

FIG. 3 is a flow chart depicting subsequent steps performed during the optimization.

Skilled artisans and practitioners will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The method and system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

One aspect of this disclosure relates to a method of optimizing a propagation prediction model having adjustable parameters in a mobile communications network. The method is performed by subdividing a service area into a plurality of map tiles, such as small geographic areas that are typically, but not necessarily, ¼ to ½ mile square, predicting a tile reliability from the model for each map tile, averaging the predicted tile reliability from all the map tiles to obtain a predicted average service area reliability, measuring a service area reliability for all the map tiles to obtain a measured service area reliability, comparing the measured service area reliability with the predicted average service area reliability, and adjusting the parameters of the model when the measured service area reliability differs from the predicted average service area reliability by a predetermined amount.

In a preferred embodiment, the measuring is performed by testing whether a communications criterion has been satisfied in each map tile, by counting how many map tiles have satisfied the criterion to obtain a total, and by dividing the total by the total number of the map tiles. Advantageously, the optimizing is iteratively performed by repeating the predicting, averaging, measuring, comparing and adjusting steps.

In addition, in a further optimization, a land mass is subdivided into a plurality of substantially uniform geomorphic regions, and the service area is associated with at least one of the regions, and the adjusted parameters for the service area are used as the basis for other service areas in the region or regions they occupy. Also, land cover data are retrieved for patches, e.g., areas that are typically, but not necessarily, thirty meters square, in each region, and each patch is associated with a terrain category, and the parameters are adjusted for each category.

Another aspect of this disclosure relates to a system for optimizing a propagation prediction model having adjustable parameters in a mobile communications network. The system includes a processor and a memory. The memory comprises instructions configured to enable the processor to subdivide a service area into a plurality of map tiles, predict a tile reliability from the model for each map tile, average the predicted tile reliability from all the map tiles to obtain a predicted average service area reliability, measure a service area reliability for all the map tiles to obtain a measured service area reliability, compare the measured service area reliability with the predicted average service area reliability, and adjust the parameters of the model when the measured service area reliability differs from the predicted average service area reliability by a predetermined amount.

Still another aspect of this disclosure relates to a computer-readable storage medium for optimizing a propagation prediction model having adjustable parameters in a mobile communications network. The medium comprises instructions that, when executed by a computer, cause the computer to subdivide a service area into a plurality of map tiles, predict a tile reliability from the model for each map tile, average the predicted tile reliability from all the map tiles to obtain a predicted average service area reliability, measure a service area reliability for all the map tiles to obtain a measured service area reliability, compare the measured service area reliability with the predicted average service area reliability, and adjust the parameters of the model when the measured service area reliability differs from the predicted average service area reliability by a predetermined amount.

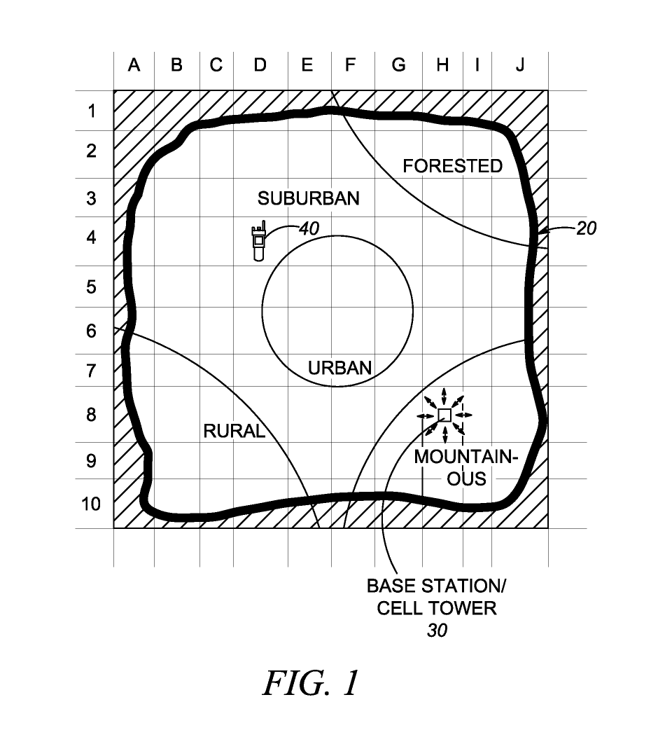

Turning now to the drawings, reference numeral 20 in FIG. 1 depicts a service area, e.g., a venue where mobile radio devices 40 (only one illustrated for simplicity) operate. These radio devices 40 may, for example, be land mobile radios (LMRs), both vehicular and handheld, which are operated by public safety personnel, such as first responders, in a public safety network having one or more base stations in radio communication with the radio devices 40, or may be handheld, mobile phones having built-in radio transceivers in radio communication with one or more cell towers in a telephone network. This invention is not intended to be limited to these specific types of networks, because other radio communication networks are also contemplated.

The service area 20 may have any environment. As illustrated, the service area 20 has urban, suburban, rural, forested and mountainous areas. It will be understood that the illustrated service area is merely exemplary, because different environments could be located in the service area 20. The service area 20 can even comprise a single environment. A radio transceiver is located at a representative station/tower 30 (only one illustrated for simplicity) operative for transmitting a radio signal to the radio devices 40 and/or for receiving a radio signal from the radio devices 40 in the service area 20.

The service area 20 is subdivided into a plurality of map tiles, e.g., small areas that are typically, but not necessarily, ¼ to ½ mile square, although other dimensions and other shapes for the map tiles are contemplated. A 10×10 grid is illustrated, where the rows are identified by the numerals 1-10, and the columns are identified by the letters A-J. Thus, the representative station/tower 30 is located in map tile H8 in the mountainous environment. It will be understood that this grid size is merely exemplary, because, in practice, the grid may have many more rows and columns.

A propagation prediction model having adjustable or tunable parameters, as described below, is then employed to predict a tile reliability for each map tile. The tile reliability is a radio coverage acceptance criterion. For example, the aforementioned empirical Okumura model may be used to predict whether or not the acceptance criterion has been met, i.e., whether an acceptable level of radio communications is present in each map tile. Each level or value is represented by a number, typically expressed as a numerical percentage. The predicted tile reliability from all the map tiles is then averaged by averaging all these numerical percentages to obtain a predicted average service area reliability, i.e., a percentage indicative of the average level of radio communications for all the map tiles in the service area 20.

Next, a service area reliability for all the map tiles is measured. This can be a measurement of the strength of the received radio signal at the radio device 40 in each map tile to test whether the strength does or does not exceed a criterion or threshold. The measurement can be objective or subjective. For example, this can be an objective measurement of the bit error rate (BER) of the received radio signal to test whether the BER does or does not exceed a criterion. This can even be a subjective listening test, in which a group of observers of the radio device 40 merely listen to the radio device 40 to rate the quality of the received signal. This latter performance measure is known as a Delivered Audio Quality (DAQ) test. Preferably, the test yields a simple yes/no result. The number of yes results compared to the total number of map tiles is then calculated to obtain a measured service area reliability, which is expressed as a numerical percentage.

Next, the measured service area reliability is compared with the predicted average service area reliability. If the measured service area reliability differs from the predicted average service area reliability by a predetermined amount, then the parameters of the model are tuned, thereby increasing the accuracy of the propagation prediction. This tuning is preferably enhanced by repeatedly and iteratively performing the above-described steps.

The parameters that may be tuned depend on the model used. For the aforementioned empirical Okumura model, there are over twenty parameters that may be tuned. For example, the Maximum Base Height Correction parameter may be tuned. In the Okumura model (and other models as well), there is a factor that accounts for the height of the antenna of the station/tower 30; the higher the antenna, the greater the gain. This gain increase does not continue to increase forever. Hence, a factor that acts as a maximum value that this gain can have can be adjusted iteratively based on tens of thousands of available measurements.

As another example, the Forested Exponent Correction parameter may be tuned. In the Okumura model, Okumura's algorithm (and those of some other models) does not account for propagation in forested environments. One common approach to this deficiency is to apply a single additional loss number for forested environments. According to this disclosure, the underlying distance-based loss that all paths experience is iteratively modified over a given distance to a value that is determined by tuning on thousands of available measurements.

As another example, the Offset Sampling parameter may be tuned. The most common approach to incorporating the effects of ground clutter is to assign a single value to each category (urban, suburban, rural, forested, etc.) in each radio frequency band. Because ground clutter type does not change instantaneously from one patch of ground to another, the values are averaged over several map tiles surrounding the map tile of interest. This also helps account for the fact that land cover data is never up-to-date. For example, if housing is expanding into a rural area, the portions that were rural when the land cover data was created might be suburban today. This method makes areas that are on the edge of suburban areas seem more, but not fully, suburban. The Offset Sampling parameter dictates over what distance to average points. This parameter is iteratively tuned based on tens of thousands of available measurements.

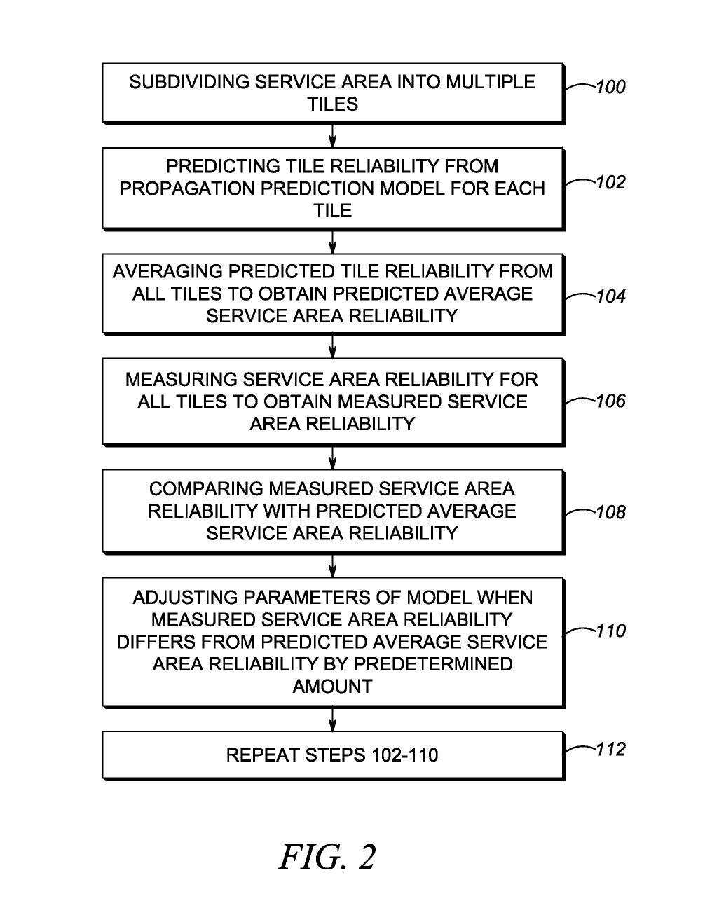

Referring now to the flow chart of FIG. 2, the method is performed by initially subdividing the service area 20 into a plurality of map tiles (step 100), predicting a tile reliability from the model for each map tile (step 102), averaging the predicted tile reliability from all the map tiles to obtain a predicted average service area reliability (step 104), measuring a service area reliability for all the map tiles to obtain a measured service area reliability (step 106), comparing the measured service area reliability with the predicted average service area reliability (step 108), adjusting the parameters of the model when the measured service area reliability differs from the predicted average service area reliability by a predetermined amount (step 110), and by repeating steps 102-110 to further enhance propagation prediction accuracy in step 112.

Further optimization can be achieved as follows: One or more land masses are each subdivided into a plurality of substantially uniform geomorphic regions. For example, the continental United States can be divided into such geomorphic regions as, for example, the Northeast region, the mid-Atlantic region, the Southern California region, the Central Plains region, the Pacific Northwest region, etc. Each of these regions contains multiple service areas. The above-described optimization performed for one service area in one region can then be used as the basis for all the other service areas in that one region, thereby eliminating the need to optimize each and every service area in that region.

In addition, land cover data for patches in each region can be retrieved from publicly available tables or databases prepared by the U.S. Geological Survey. Each patch, typically a geographic square area measuring about 30 meters×30 meters in area, is assigned a terrain category, e.g., forested, mountainous, etc. The parameters for each terrain category are then adjusted.

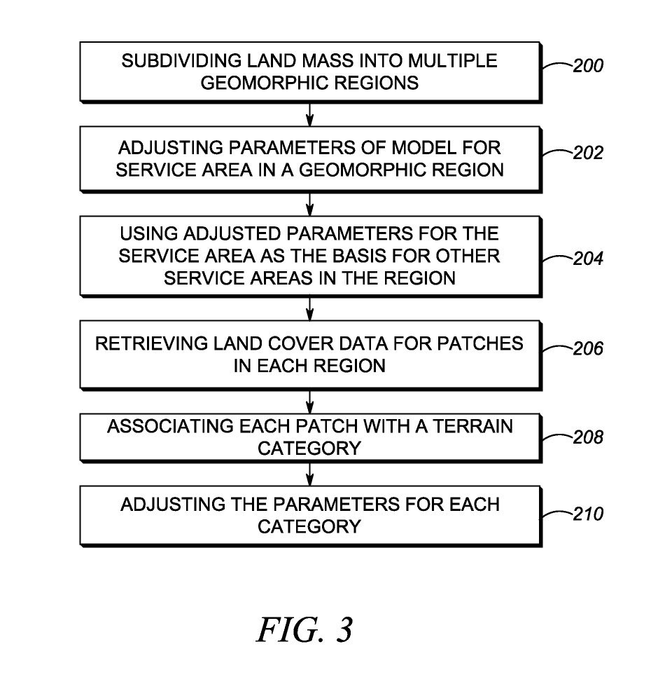

The flow chart of FIG. 3 depicts this further optimization. Thus, step 200 depicts the subdividing of a land mass into a plurality of substantially uniform geomorphic regions, step 202 depicts adjusting the model parameters for a selected service area with a selected region, and step 204 depicts using the adjusted parameters for the selected service area as the basis for other service areas in the selected region. In addition, step 206 depicts retrieving land cover data for patches in each region, step 208 depicts associating each patch with a terrain category, and step 210 depicts adjusting the parameters for each terrain category.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method of optimizing a propagation prediction model having adjustable parameters in a mobile communications network, the method comprising:
subdividing a service area into a plurality of map tiles;
predicting a tile reliability from the model for each map tile;
averaging the predicted tile reliability from all the map tiles to obtain a predicted average service area reliability;
measuring a service area reliability for all the map tiles to obtain a measured service area reliability;
comparing the measured service area reliability with the predicted average service area reliability; and
adjusting the parameters of the model when the measured service area reliability differs from the predicted average service area reliability by a predetermined amount.

2. The method of claim 1, wherein the subdividing is performed by configuring the map tiles as individual areas arranged in rows and columns within the service area.

3. The method of claim 1, wherein the predicting is performed by retrieving data from databases.

4. The method of claim 1, wherein the averaging is performed by adding the predicted map tile reliabilities from all the map tiles to form a sum, and then by dividing the sum by the total number of the map tiles.

5. The method of claim 1, wherein the measuring is performed by determining whether or not a communications signal exceeding a threshold is received in each map tile.

6. The method of claim 1, wherein the measuring is performed by testing whether a communications criterion has been satisfied in each map tile, by counting how many map tiles have satisfied the criterion to obtain a total, and by dividing the total by the total number of the map tiles.

7. The method of claim 1, wherein the measuring is performed by one of a subjective test and an objective test.

8. The method of claim 1, wherein the optimizing is iteratively performed by repeating the predicting, averaging, measuring, comparing and adjusting steps.

9. The method of claim 1, and subdividing a land mass into a plurality of substantially uniform geomorphic regions, associating the service area with at least one of the regions, and using the adjusted parameters for the service area as the basis for other service areas in the at least one region.

10. The method of claim 9, and retrieving land cover data for patches in each region, associating each patch with a terrain category, and adjusting the parameters for each category.

11. The method of claim 1, wherein the adjusting is performed by adjusting an offset sampling parameter of the model.

12. A system for optimizing a propagation prediction model having adjustable parameters in a mobile communications network, the system comprising:
a processor; and
a memory comprising instructions configured to enable the processor to subdivide a service area into a plurality of map tiles, predict a tile reliability from the model for each map tile, average the predicted tile reliability from all the map tiles to obtain a predicted average service area reliability, measure a service area reliability for all the map tiles to obtain a measured service area reliability, compare the measured service area reliability with the predicted average service area reliability, and adjust the parameters of the model when the measured service area reliability differs from the predicted average service area reliability by a predetermined amount.

13. The system of claim 12, wherein the instructions are iteratively performed.

14. The system of claim 12, wherein the instructions are further configured to enable the processor to subdivide a land mass into a plurality of substantially uniform geomorphic regions, associate the service area with at least one of the regions, and use the adjusted parameters for the service area as the basis for other service areas in the at least one region.

15. The system of claim 14, wherein the instructions are further configured to retrieve land cover data for patches in each region, associate each patch with a terrain category, and adjust the parameters for each terrain category.

16. A computer-readable storage medium for optimizing a propagation prediction model having adjustable parameters in a mobile communications network, the medium comprising instructions, which when executed by a computer, cause the computer to:
subdivide a service area into a plurality of map tiles,
predict a tile reliability from the model for each map tile,
average the predicted tile reliability from all the map tiles to obtain a predicted average service area reliability,
measure a service area reliability for all the map tiles to obtain a measured service area reliability,
compare the measured service area reliability with the predicted average service area reliability, and
adjust the parameters of the model when the measured service area reliability differs from the predicted average service area reliability by a predetermined amount.

17. The medium of claim 16, wherein the instructions are iteratively performed by the computer.

18. The medium of claim 16, wherein the instructions further cause the computer to subdivide a land mass into a plurality of substantially uniform geomorphic regions, associate the service area with at least one of the regions, and use the adjusted parameters for the service area as the basis for other service areas in the at least one region.

19. The medium of claim 18, wherein the instructions further cause the computer to retrieve land cover data for patches in each region, associate each patch with a terrain category, and adjust the parameters for each terrain category.
